(19) United States
(12) Patent Application Publication
(10) Pub. No.: US 2008/0163454 A1
(43) Pub. Date: Jul. 10, 2008

(54) Fire-Protection Arrangement For an Installation In a Partition

(75) Inventors: Roy Olsson, Fagelmara (SE); John E. Dower, Cheshire (GB)

Correspondence Address: SCHWEGMAN, LUNDBERG & WOESSNER, P.A., P.O. BOX 2938, MINNEAPOLIS, MN, 55402, US

(73) Assignee: MCT BRATTBERG AKTIEBOLAG, Karlskrona (SE)

(21) Appl. No.: 11/661,032

(22) PCT Filed: Aug. 24, 2005
(86) PCT No.: PCT/EP2005/054155

§ 371 Date: Sep. 25, 2007

Related U.S. Application Data
(60) Provisional application No. 60/522,303, filed on Sep. 14, 2004.

(30) Foreign Application Priority Data
Aug. 24, 2004 (SE) 0402060-8
May 2, 2005 (SE) 0500996-4

(51) Int. Cl. F16L 5/04

(52) U.S. Cl. 16/2.1

(57) ABSTRACT

A fire-protection arrangement (21) for an installation (1, 4) is described, for example a lead-through arrangement, for example for cables or pipes, in a partition (2), for example a wall. The fire-protection arrangement (21) is arranged to be mounted on one side of the partition (2) in such a way that it at least partially surrounds the installation (1, 4).

The invention relates to a fire-protection arrangement for an installation, for example a lead-through arrangement, for example for cables or pipes, in a partition, for example a wall.

### BACKGROUND ART

With more stringent fire safety requirements being introduced within a number of different areas, there is a need for new technical solutions to prevent or delay the spread of a fire, and/or to protect important installations in a structure in which a fire can occur. For example, a bushing for cables or pipes in a wall or a bulkhead can create an opening through which a fire can spread.

Concerning bushings, traditional cable bushings are described in, for example, U.S. Pat. No. 2,732,226, U.S. Pat. No. 3,489,440 or U.S. Pat. No. 4,767,086. Such bushings are used, for example, to lead cables through bulkheads in a vessel. With reference to the attached drawings (FIGS. 1 and 2) from U.S. Pat. No. 2,732,226, the cables (3) are accommodated in flexible packing elements (4) which, in turn, are supported by a rectangular frame (1) that is welded to the wall, plate or bulkhead (2) through which the cables are to be taken.

In spite of the fact that cable bushings of the type that is shown in U.S. Pat. No. 2,732,226 provide a high degree of fire protection, since the time of the development of this known solution, even more stringent requirements have been made concerning fire protection characteristics of cable bushings, which have created a need for additional solutions in order to increase the resistance to fire.

### SUMMARY

An object of the present invention is to improve the fire protection for installations, for example lead-through arrangements, for example for cables or pipes.

Another object of the invention is to improve the fire protection for installations, for example lead-through arrangements, for example for cables or pipes, while retaining good access to the installation.

This object is achieved with a fire-protection arrangement for an installation, for example a lead-through arrangement, for example for cables or pipes, in a partition, for example a wall, characterized in that it is arranged to be mounted on one side of the partition in such a way that it at least partially surrounds the installation.

Tests have shown that, in the event of a fire on one side of a partition in the form of a wall or bulkhead, the partition is heated up whereby heat spreads in the plane of the partition. Thus, an installation in the partition can be heated up as a result of its contact with the partition. As explained in greater detail in the detailed description below, the fire-protection arrangement acts as a shield which, in the event of fire, suppresses the heating up of the partition around the installation, so that the heating up of the installation is in turn suppressed.

The design according to the invention, in which the fire-protection arrangement surrounds the installation, means that the fire-protection arrangement can be designed in such a way that the installation is not completely covered, but is accessible, for example for inspection.

The fire-protection arrangement has preferably an extent parallel to the partition that is greater than its extent perpendicular to the partition. By this means, the shielding characteristics of the fire-protection arrangement are further increased.

The fire-protection arrangement is preferably in contact with the partition. By means of its contact with the partition, the fire-protection arrangement will absorb at least a part of the heat that would otherwise have spread to the installation. In this way, the heating up of the installation is suppressed. As a result, in the case of the installation being a bushing, spreading of the fire is prevented or delayed.

At least a part of the fire-protection arrangement is preferably constructed of a non-combustible material. This further reduces the risk of the fire spreading to the installation or delays its spread. The combustible material preferably surrounds the installation.

The fire-protection arrangement preferably extends further out from the partition than the installation. This, in combination with the fact that the fire-protection arrangement at least partially surrounds the installation, means that a space is created outside the installation, which space is delimited by the part of the fire-protection arrangement that projects beyond the installation. Tests have shown that, in the event of a fire, the temperature in such a space is lower than in the surrounding gas, which in turn means that the temperature in the installation, which is adjacent to the said delimited space, is lower. By this means, the spread of the fire to the installation is prevented or delayed.

The fire-protection arrangement preferably comprises a plurality of frame elements that are arranged, when the fire-protection arrangement is mounted, to be arranged in contact with each other and in sequence around the perimeter of the installation, with at least one cover element being provided to cover at least a part of a joint between two frame elements. The fact that the fire-protection arrangement comprises frame elements means that it can be provided as a modular system in which a simple adaptation can be carried out to the size of a specific installation, by means of a suitable combination of a plurality of frame elements. However, in the event of a fire, it is possible for the partition to be deformed out of its plane, for example by buckling, so that it has locally a curved shape. This can result in the frame elements assuming a tilted position in relation to each other, which in turn means that the distance between the joints increases, in other words there are gaps between them. By providing a cover element that covers at least a part of a joint between two frame elements, in the event of a fire, a flame is prevented from penetrating into a gap between the frame elements and, in this way, the heating up of the partition is reduced.

The cover element is preferably arranged to extend on the outside of the frame elements, and along the joint, and to be attached to the partition. By this means, the cover element can also act as a fixing element for the frame elements.

The fire-protection arrangement preferably comprises a plurality of frame elements that are arranged, when the fire-protection arrangement is mounted, to be arranged in contact with each other and in sequence around the perimeter of the installation, with at least one engagement element being arranged in at least one joint between two frame elements, with the engagement element having a shape that at least partially corresponds to the shape of at least one recess in at least one of the frame elements. This means that displacement between the frame elements is prevented or made more difficult, in particular relative displacement in a direction that is parallel to the plane of the division between two frame elements and parallel to the partition. This increases the stability of the fire-protection arrangement, in particular in the event of a fire, as deformations in the partition caused by heat have a tendency to move the frame elements in relation to each other.

The fire-protection arrangement preferably comprises a plurality of layers that are arranged parallel to the partition when the fire-protection arrangement is mounted, with at least one of the layers being a layer with low heat conductivity.

### BRIEF DESCRIPTION OF DRAWINGS

The invention will be described in greater detail below with reference to the attached drawings, in which:

FIGS. 1 and 2 show a view from in front and a sectioned view respectively of a cable lead-through arrangement according to known technology,

FIG. 3 shows a view from in front of a fire-protection arrangement, according to an embodiment of the invention, for a cable lead-through arrangement,

FIG. 4 shows a sectioned view, with the section taken along the line IV-IV in FIG. 3,

FIG. 5 shows a view from in front of a fire-protection arrangement, according to an alternative embodiment of the invention,

FIG. 6 shows a sectioned view, with the section taken along the line VI-VI in FIG. 5, and

FIG. 7 shows schematically a cross-section of a part of the fire-protection arrangement in FIGS. 5 and 6 in the event of deformation of the partition caused by heat.

### MODE(S) FOR CARRYING OUT THE INVENTION

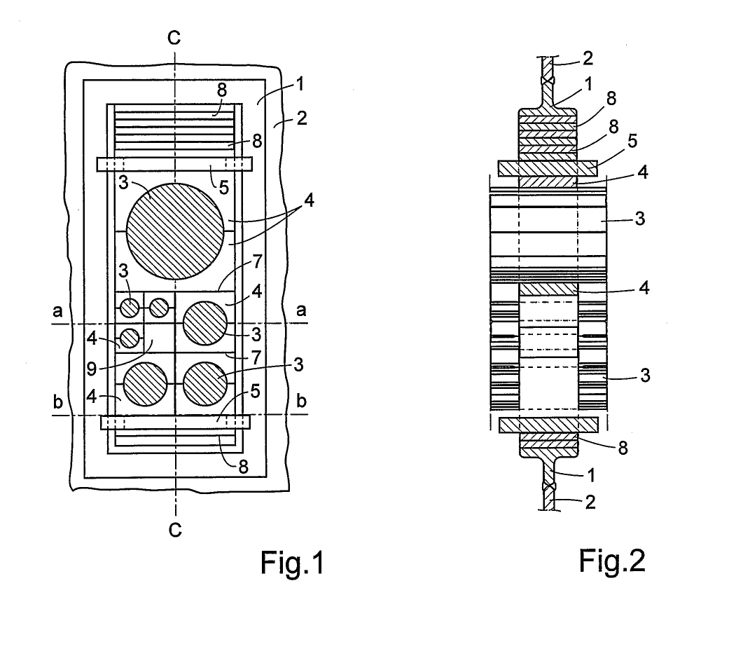

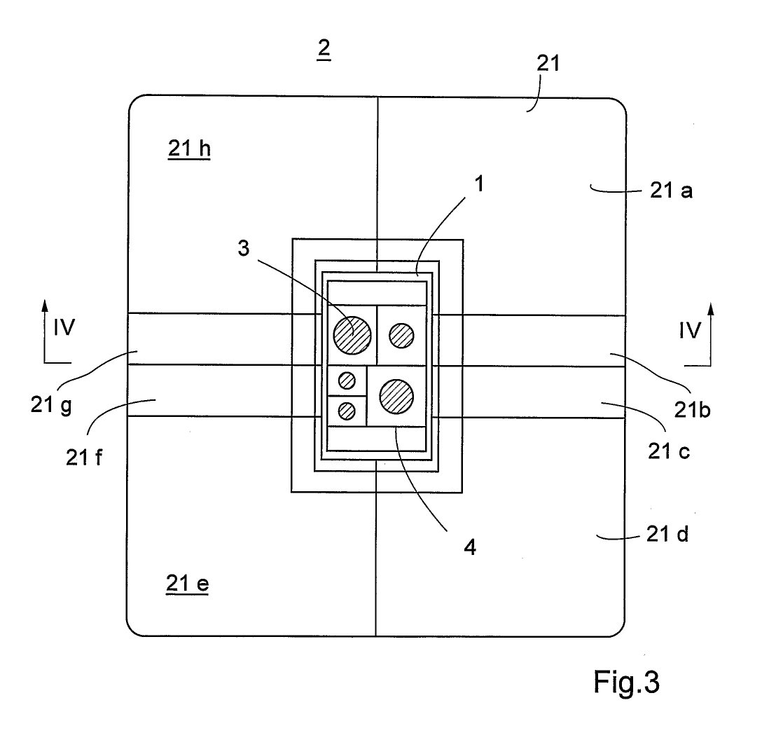

FIG. 3 shows a fire-protection arrangement 21 according to an embodiment of the invention, in the form of a protective frame 21, mounted on one side of a partition 2 in the form of a wall 2. The partition can also be a bulkhead, a ceiling, a floor or a deck. The protective frame 21 surrounds an installation 1, 4 in the form of a cable lead-through arrangement 1, 4, comprising a frame 1 that supports flexible packing elements 4, which, in turn, support cables 3 according to known technology, see also the description in the introduction above with reference to FIGS. 1 and 2.

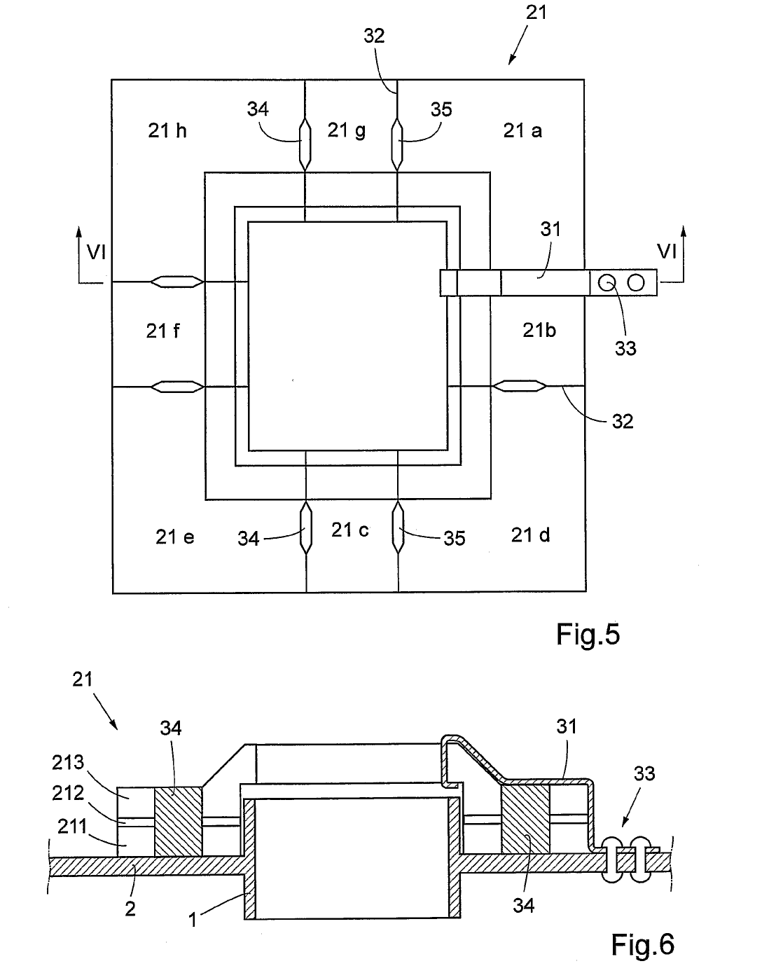

The protective frame 21 can be mounted by means of any suitable fixing arrangement, for example a welded joint, bolt connection or in the way that is described below with reference to FIGS. 5 and 6.

The protective frame 21 comprises frame elements 21a-21h which are arranged to lie adjacent to each other around the perimeter of the frame. These frame elements 21a-21h can be comprised in a modular system, by means of which protective frames can be adapted to installations 1, 4 of different sizes. Alternatively, the protective frame 21 can, of course, consist of one continuous element.

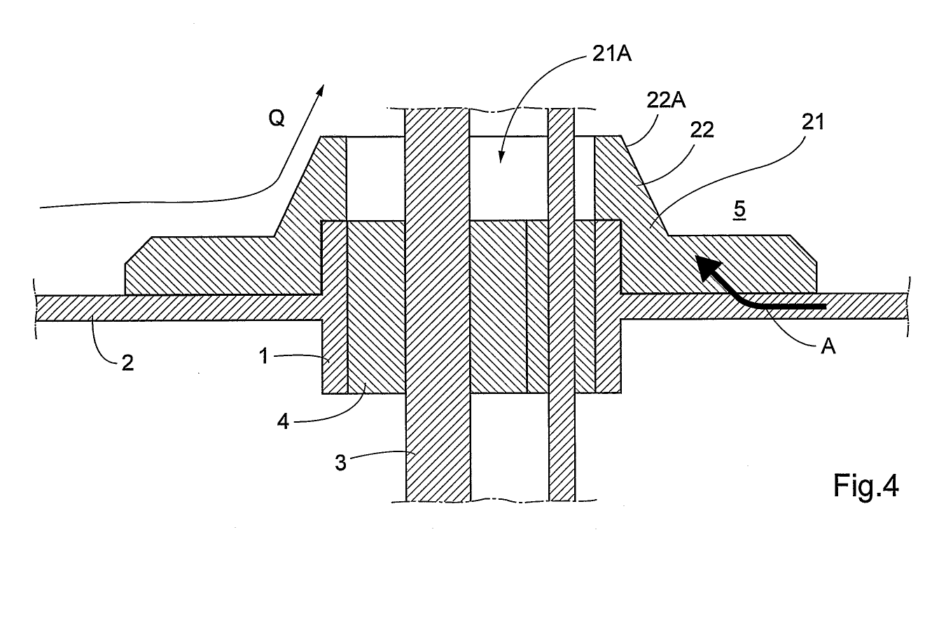

The protective frame 21 acts as a shield that, in the event of a fire, suppresses the transmission of heat from one area (in FIG. 4 indicated by the reference numeral 5), that is adjacent to the wall 2 and the cable lead-through arrangement 1, 4, to the wall 2, and thereby suppresses the heating up of the wall 2, so that the heating up of the cable lead-through arrangement 1, 4 is suppressed in turn. The protective frame 21 has preferably an extent parallel to the wall 2 that is greater than its extent perpendicular to the wall 2. The relatively large extent parallel to the wall 2 means that the shielding characteristics of the protective frame are further increased.

As shown in FIG. 4, the protective frame 21 is in contact with the wall 2. By this means, the protective frame 21 can absorb heat that spreads through the wall 2, and in this way reduce the transmission of heat to the cable lead-through arrangement 1, 4 which is illustrated with the arrow A in FIG. 4. By this means, the spread of the fire to the cable lead-through arrangement 1, 4 is prevented or delayed and the spread of the fire to the other side of the wall 2 is thus made more difficult. The protective frame 21 is preferably in contact with the wall 2 around essentially the whole cable lead-through arrangement 1, 4.

The protective frame is provided with a flange 22 so that the protective frame 21 extends further out from the wall 2 than the cable lead-through arrangement 1, 4. This, in combination with the fact that the protective frame 21 surrounds the cable lead-through arrangement 1, 4, means that a space 21A is created outside the cable lead-through arrangement 1, 4, which space is delimited by the part of the protective frame 21 that projects beyond the cable lead-through arrangement 1, 4. As pointed out above, in the event of a fire, the temperature in such a space 21A is lower than in the surrounding gas, which reduces the heating up of the cable lead-through arrangement 1, 4.

The flange 22 has an inclined outer side 22A and thereby serves to guide a flame or heat that approaches along the wall 2 away from the cable lead-through arrangement 1, 4, which is illustrated by the arrow Q in FIG. 4.

As shown in FIGS. 3 and 4, the protective frame 21 is open at its central part, which means that easy access to the cable lead-through arrangement 1, 4 is possible. In other words, the invention provides increased fire protection of the installation without a reduction in the ability to access the installation, for example for inspection, repairs or other measures.

FIGS. 5 and 6 show a fire-protection arrangement 21 according to a further embodiment of the invention, in the form of a protective frame 21. The embodiment shown in FIGS. 5 and 6 conforms in many respects to the embodiment described above with reference to FIGS. 3 and 4. The protective frame 21 is thus mounted on one side of a partition 2 and surrounds a frame 1 comprised in an installation in the form of a cable lead-through arrangement, with the frame being arranged to support flexible packing elements (not shown in FIGS. 5 and 6) as described above.

As in the embodiment described above, the protective frame 21 comprises frame elements 21a-21h. The frame elements 21a-21h are arranged adjacent to each other and in sequence around the perimeter of the installation 1. FIGS. 5 and 6 show a cover element 31 in the form of a stainless steel strip. The cover element 31 extends along a joint 32 between two frame elements 21a, 21b, on the outside of the frame elements 21a, 21b and thereby covers the joint 32 on the outside of the frame elements. FIG. 5 shows only one cover element, for the purpose of illustration, but a cover element is preferably provided at each joint 32 between two frame elements. Alternatively, one cover element can have an extent that is such that it covers more than one joint 32.

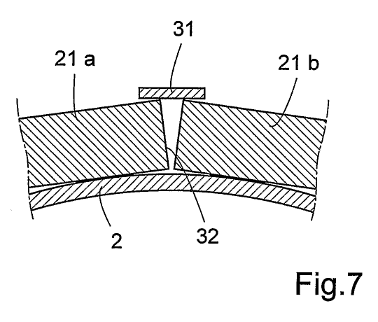

FIG. 7 illustrates (with exaggerated displacements for the sake of clarity) one of the functions of the cover element 31. In the event of a fire, it is possible for the partition 2 to buckle, so that it has locally a curved shape. This can mean that the frame elements 21a, 21b assume a tilted position in relation to each other, which, in turn, means that a gap is created in the joint 32 between the frame elements. The cover element 31 thereby prevents a flame from penetrating into the gap and, in this way, reduces the spread of heat to the partition 2.

The cover element 31 is attached to the partition 2 by means of a screw connection 33. By this means, the cover element 31 can also act as a fixing element for the frame elements 21a, 21b. Of course, alternatively, rivets, welding or some other suitable means can be used for attaching the cover element to the partition 2.

In the example shown in FIGS. 5 and 6, there is an engagement element 34 placed in each joint 32 between two frame elements 21a-21h. The engagement element 34 has a shape that corresponds to the shape of the recesses 35 in the adjacent frame elements, in such a way that the engagement element engages the frame elements. This means that displacement between the frame elements is prevented or made more difficult, in particular relative displacement in a direction that is parallel to the plane of the division between two frame elements and parallel to the partition. This increases the stability of the fire-protection arrangement 21, in particular in the event of a fire, as deformations in the partition 2 caused by heat have a tendency to move the frame elements 21a-21h in relation to each other.

In this example, each engagement element extends from the partition 2 when mounted and has a hexagonal cross section and is arranged symmetrically in the plane of the division between two frame elements 21a-21h. However, several alternative shapes are possible for the engagement elements, for example with rectangular, elliptical or asymmetrically rounded or polygonal cross sections. In addition, each engagement element can be designed as a projecting part permanently attached to a frame element, which part is arranged to engage with a recess arranged in an adjacent frame element, which recess has a shape that corresponds to the shape of the projecting part.

In this example, only one engagement element 34 is shown in each joint 32, but of course several engagement elements can alternatively be provided in each joint, with a corresponding number of recesses being provided in the frame elements at the respective joints.

As shown in FIG. 6, the fire-protection arrangement 21 comprises several layers 211, 212, 213 that are oriented parallel to the partition 2 when mounted. More specifically, the fire-protection arrangement 21 comprises an inner layer 211, an intermediate layer 212 and an outer layer 213. The inner and the outer layers 211, 213 comprise a non-combustible material, for example a material that is marketed under the trademark “Comfire” by Marine Systems Technology Ltd. in Great Britain. The intermediate layer 212 comprises material with low heat conductivity and acts as a heat shield to reduce the spread of heat towards the partition 2.

1. Fire-protection arrangement for an installation having a lead-through arrangement in a partition, comprising at least one element to be mounted on one side of the partition in such a way that the lement at least partially surrounds the installation.

2. Fire-protection arrangement according to claim 1, wherein the element includes an extent parallel to the partition that is greater than its extent perpendicular to the partition.

3. Fire-protection arrangement according to wherein the element is in contact with the partition.

4. Fire-protection arrangement according to claim 1, wherein at least a part of the fire-protection arrangement is constructed of a non-combustible material.

5. Fire-protection arrangement according to claim 1, wherein the element extends further out from the partition than the installation.

6. Fire-protection arrangement (21) according to claim 1, wherein the element comprises a plurality of frame elements that are arranged, when the fire-protection arrangement is mounted, to be in contact with each other and in sequence around the perimeter of the installation, and at least one cover element being provided to cover at least a part of a joint between two frame elements.

7. Fire-protection arrangement according to claim 6, in which the cover element is arranged to extend on the outside of the frame elements, and along the joint, and to be attached to the partition.

8. Fire-protection arrangement according to claim 1, wherein the element comprises a plurality of frame elements that are arranged, when the fire-protection arrangement is mounted, to be in contact with each other and in sequence around the perimeter of the installation, and at least one engagement element being arranged in at least one joint between two frame elements, the engagement element having a shape that at least partially corresponds to the shape of at least one recess in at least one of the frame elements.

9. Fire-protection arrangement according to claim 1, wherein the element comprises a plurality of layers that are arranged parallel to the partition when the fire-protection arrangement is mounted, with at least one of the layers being a layer with low heat conductivity
